(19) United States
(12) Patent Application Publication
(10) Pub. No.: US 2017/0336678 A1
(43) Pub. Date: Nov. 23, 2017

(54) ONBOARD LIQUID CRYSTAL DISPLAY DEVICE AND MANUFACTURING METHOD THEREOF, AND VEHICLE

(71) Applicant: BOE TECHNOLOGY GROUP CO., LTD., Beijing (CN)

(72) Inventors: Naifu Wu, Beijing (CN); Wei Wei, Beijing (CN); Kun Wu, Beijing (CN); Tao Wang, Beijing (CN); Bei Niu, Beijing (CN)

(21) Appl. No.: 15/528,428

(22) PCT Filed: Oct. 10, 2016
(86) PCT No.: PCT/CN2016/101648

§ 371 Date: May 19, 2017

(30) Foreign Application Priority Data
Oct. 23, 2015 (CN) 201510698150.9

(51) Int. Cl. G02F 1/1335; B60K 35/00

(52) U.S. Cl. CPC G02F 1/133621; B60K 35/00; G02F 1/133512; B60K 2350/2008; B60K 2350/1096; B60K 2350/2034; B60K 2350/2039; B60K 2350/2021

(57) ABSTRACT

An onboard liquid crystal display device and a method of manufacturing the onboard liquid crystal display device, and a vehicle having the onboard liquid crystal display device are disclosed. The onboard liquid crystal display device includes at least one backlight source and a liquid crystal panel having no color filter layer.

### CROSS REFERENCE TO RELATED APPLICATIONS

This application is a Section 371 National Stage application of International Application No. PCT/CN2016/101648, filed on 10 Oct. 2016, entitled “ONBOARD LIQUID CRYSTAL DISPLAY DEVICE AND MANUFACTURING METHOD THEREOF, AND VEHICLE”, which claims priority to Chinese Application No. 201510698150.9, filed on 23 Oct. 2015, incorporated herein by reference in its entirety.

### TECHNICAL FIELD

The present disclosure relates to the field of onboard displays, and specially, to an onboard liquid crystal display device and a method of manufacturing the onboard liquid crystal display device, and a vehicle having the onboard liquid crystal display device.

### BACKGROUND

In current technical field of onboard display, in order to increase safety of a driver, head-up display technology has been introduced, which relates to a device on which traffic information can be read when viewing horizontally.

Onboard display technology is based on projection, which needs high contrast for human's eyes to recognize and read information displayed on the device in sunny days. Therefore, high intensity backlight is needed. However, the question is that, when the intensity of backlight is high, temperature will raise quickly, and an over high temperature will affect display effect and stability of the device. In this regard, a customary way is enlarging a bulky heat radiating device, which will occupy more inner space of the vehicle which is narrow and small.

There is needed an onboard display device, which may provide a good display effect without a high intensity backlight. In order to provide a clear display, a current head-up display device based on liquid crystal display requires high intensity backlight (for example, an intensity of about 650,000 nits) due to low transmissivity of a liquid crystal panel (the transmissivity is about 4%). This high intensity backlight will bring high heat dissipation, and the display device may not operate normally due to high temperature. Therefore, there is needed a display device, which may clearly display information without generating too much heat.

### SUMMARY

An object of the present disclosure is to provide an onboard liquid crystal display device and a method of manufacturing the onboard liquid crystal display device, and a vehicle having the onboard liquid crystal display device, which may overcome at least one aspect of the above mentioned problems or disadvantages in prior arts.

According to one aspect of the present disclosure, there is provided an onboard liquid crystal display device, which includes at least one backlight source and a liquid crystal panel having no color filter layer.

According to another aspect of the present disclosure, there is provided a method of manufacturing an onboard liquid crystal display device, including: forming at least one backlight source; and forming a liquid crystal panel without any color filter layer.

According to another aspect of the present disclosure, there is provided a vehicle, which includes the onboard liquid crystal display device.

The onboard liquid crystal display device according to the present disclosure includes at least one backlight source and a liquid crystal panel having no color filter layer. The onboard liquid crystal display device can display information clearly without generating too much heat, can display images with high efficiency and ensure sufficient brightness at the same time. Power consumption of the device is low, and corresponding manufacturing process thereof is simplified.

### BRIEF DESCRIPTION OF THE DRAWINGS

FIG. 1 shows an illustrative exploded view of an onboard liquid crystal display device according to an embodiment of the present disclosure;

FIG. 2 shows a light-shielding element of an onboard liquid crystal display device according to an embodiment of the present disclosure;

FIG. 3 shows an example of display an onboard liquid crystal display device and an arrangement of backlight sources according to an embodiment of the present disclosure;

FIG. 4 shows an example of display an onboard liquid crystal display device and an arrangement of backlight sources according to another embodiment of the present disclosure; and

FIG. 5 shows an example of display an onboard liquid crystal display device and an arrangement of backlight sources according to a further embodiment of the present disclosure.

### DETAILED DESCRIPTION OF PREFERRED EMBODIMENTS

Embodiments of the present disclosure will now be described in detail and illustratively shown in appended drawings, where like numerals indicate like elements. The embodiments of the present disclosure will be described in conjunction with the drawings for purpose of expatiation of the present disclosure.

According to an embodiment of the present disclosure, there is provided an onboard liquid crystal display device. As shown in FIG. 1, the onboard liquid crystal display device may include a backlight source 10 and a liquid crystal panel 20. Existing liquid crystal display panels or liquid crystal displays include color filter layers. However, the onboard liquid crystal display device or the liquid crystal panel according to the embodiment of the present disclosure does not include any color filter layer. Since the need of the color filter layer is eliminated, transmissivity of the liquid crystal panel may be increased. For example, in an example, since there is no color filter layer, light transmissivity of the liquid crystal display panel may be increased to 15% or even higher. Such a liquid crystal display panel may provide required display clarity while the requirement for backlight can be significantly reduced.

According to an embodiment of the present disclosure, the onboard liquid crystal display device includes a backlight source and a liquid crystal panel. Specifically, the onboard liquid crystal display device may include a first polarizer 201, a thin film transistor array 203, a liquid crystal layer 204 and a second polarizer 202, as shown in FIG. 1. A color filter layer, which is necessary for an existing liquid crystal panel, is not provided in the onboard liquid crystal display device according to the embodiment of the present disclosure. As shown in FIG. 1, light emitted by the backlight source 10 is transmitted from the backlight source, and passes through the first polarizer 201, the thin film transistor array 203, the liquid crystal layer 204 and the second polarizer 202, and light intensity of final exiting light gradually reduces. Since the color filter layer is eliminated, in the case that the same backlight source is used, intensity of final exiting light from the onboard liquid crystal display device according to the embodiment of the present disclosure is higher than that from an existing liquid crystal display device provided with a color filter layer.

Considering the requirement on display of the onboard liquid crystal display device, in fact, a liquid crystal panel without any color filter may also provide clearly displayed information. Therefore, the liquid crystal display device according to the embodiment of the present disclosure can not only display information clearly, but also decrease brightness of backlight and reduce heat dissipation and power consumption.

According to an embodiment of the present disclosure, the onboard liquid crystal display device includes a display region, and the backlight source for the display region may include, for example, a red backlight source, a green backlight source, a blue backlight source, or a white backlight source. It may also include backlight sources of two or more colors.

According to an embodiment of the present disclosure, the onboard liquid crystal display device includes at least two display regions, for example, two display regions, W and R, each display region is used to display respective information independently. For example, one display region W of the onboard liquid crystal display device may digitally display vehicle speed, engine speed, water temperature, endurance mileages, oil consumption or the like, or, it may also indicate, as a speed indicator, the vehicle speed, the engine speed or the like. Another display region G of the onboard liquid crystal display device is used to display navigation information, such as forward turning indication or the like. The onboard liquid crystal display device may further have a display region R for displaying warning information, e.g., the information regarding speed limit, camera snapshot or the like. The onboard liquid crystal display device may further have more display regions, which may be provided as required.

The onboard liquid crystal display device may utilize backlight sources of one color. For example, one or at least two display regions utilize backlight sources of one color, such as white backlight sources, blue backlight sources or green backlight sources, or backlight sources of another color. In other words, backlight sources of these display regions have the same color. Each display region may work independently, for example, each display region may have its own display brightness, and may be independently turned on or off, and may flicker (i.e., be turned on and off periodically) independently.

In another embodiment of the present disclosure, the onboard liquid crystal display device may utilize backlight sources of multiple colors, and backlight sources of a respective color are operated independently. For example, each display region may include one kind of backlight sources that can be operated independently. In one embodiment of the present disclosure, each display region may, for example, include backlight sources of one color that can be operated independently from other display regions, the operations may relate to brightness adjustment, turning on or off, and flickering (i.e., turning on and off periodically). In an embodiment of the present disclosure, backlight sources of each display region may have their own color, that is, different display regions are provided with backlight sources of different colors. For example, the display region W utilizing white backlight sources displays vehicle speed, engine speed, water temperature, endurance mileages, oil consumption or the like, as shown in FIG. 3; the display region G including green backlight sources displays indication information, such as navigation information, forward turning indication or the like, as shown in FIG. 3; the display region R including red backlight sources displays warning information, for example, the information regarding speed limit, camera snapshot or the like. However, the present disclosure is limited to the above embodiments, and other colors may also be utilized for display. In practice, the onboard liquid crystal display device according to the embodiments of the present disclosure can clearly display desired information, and meanwhile, power consumption and heat dissipation can be controlled within reasonable ranges.

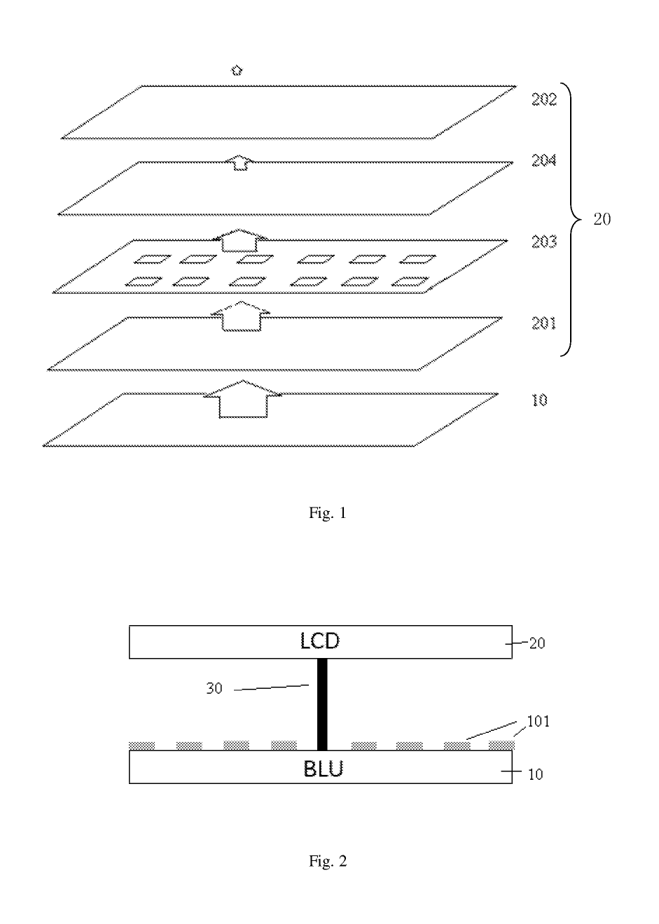

According to an embodiment of the present disclosure, as shown in FIG. 2, a light-shielding element 30 is provided between different display regions of the onboard liquid crystal display device, to separate backlight of different display regions. The light-shielding element 30 is beneficial, for example, when different display regions are provided with backlight sources (for example, LEDs 110) of different colors, light of different colors may be separated by the light-shielding element 30, such that light of different colors may not interfere with each other. However, it can be appreciated that, the onboard liquid crystal display device according to the embodiments of the present disclosure can operate normally without the light-shielding element. In an embodiment, the light-shielding element 30 may also be provided between display regions of the same color.

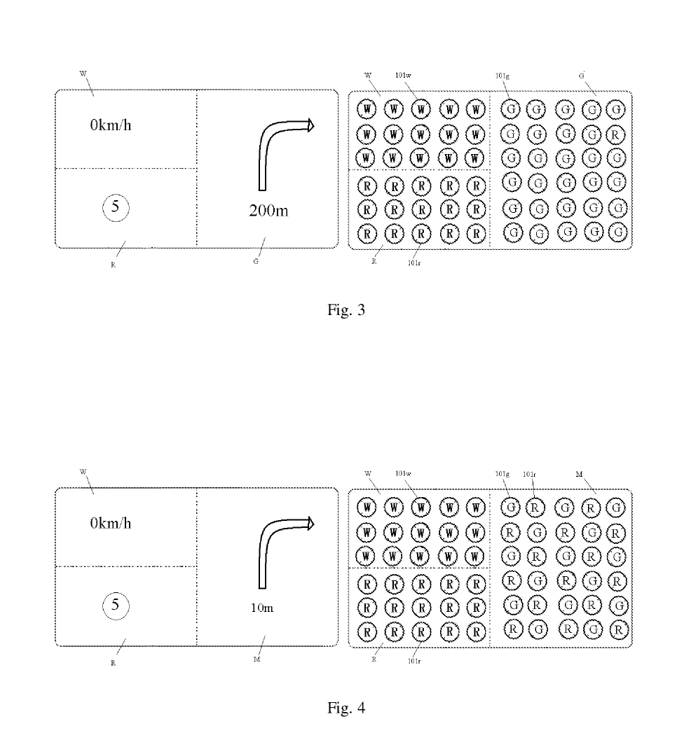

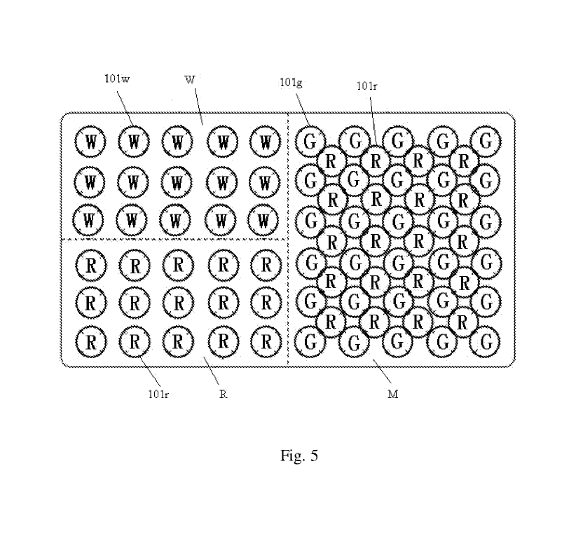

In an embodiment of the present disclosure, at least one display region of the onboard liquid crystal display device includes at least one mixed-color backlight display region M. For example, at least one display region of the onboard liquid crystal display device includes one mixed-color backlight display region M, which includes backlight sources of at least two different colors, and the backlight sources of at least two different colors are arranged alternately or in a mixed way, as shown in FIG. 4. In FIG. 4, the mixed-color backlight display region M includes a plurality of LEDs including green LEDs 101g and red LEDs 101r that are arranged adjacently. In other words, each green LED 101g is arranged adjacent to a red LED 101r, and each red LED 101r is arranged adjacent to a green LED 101g. In an embodiment, LED distribution density of a LED array consisted of the green LEDs 101g and the red LEDs 101r may be the same as those of backlight LEDs in other display regions. In other words, parts of green LED 101g are replaced by red LEDs 101r to provide the mixed-color backlight sources. In another embodiment of the present disclosure, in order to improve display brightness and display effect, green LEDs 101g and red LEDs 101r are alternately arranged and the red LEDs 101r and the green LEDs 101g are arranged in close proximity to each other, as shown in FIG. 5. The arrangement of LEDs of the mixed-color backlight display region shown in FIG. 5 greatly increases the distribution density of the LEDs, such that display brightness and display effect are improved. In other embodiments of the present disclosure, backlight LEDs may also be arranged in different manners. In other embodiments of the present disclosure, the mixed-color backlight display region M may include a mixed arrangement of LEDs of other two different colors. In other embodiments of the present disclosure, the mixed-color backlight display region M may include a mixed arrangement of LEDs of three or four different colors.

In an embodiment, mixed-color backlight display region M may display alternately and flickeringly. For example, red LED backlight sources (including a plurality of LEDs 101r) and green LED backlight sources (including a plurality of LEDs 101g) emit light alternately, such that the mixed-color backlight display region display a red image and a green image alternately and flickeringly. The image displayed by the light emitted by the red LEDs and the image displayed by the light emitted by the green LEDs may be the same or different. In other embodiments of the present disclosure, the mixed-color backlight display region M may utilize two colors other than red and green to display images alternately. In an embodiment of the present disclosure, the mixed-color backlight display region M may display an image alternately in a certain sequence in three or more colors. For example, backlight sources of the mixed-color backlight display region M may include red LEDs, green LEDs and blue LEDs, and these backlight sources may emit light in a desired sequence to display images of different colors. The effect of displaying flickeringly can be conspicuous, and drivers' attentions may be easily attracted by the flickeringly displayed images. In another embodiment, backlight sources of all colors in the mixed-color backlight display region M emit light simultaneously. For example, the mixed-color backlight display region includes red LEDs and green LEDs, and the red LEDs and the green LEDs may emit light simultaneously, and emitted light are mixed to display an image of orange color.

In an embodiment, the mixed-color backlight display region M may not display images of different colors alternately, but displays an image of one color in a certain time period, for example, only a red image, a green image, a blue image or the like is displayed.

In an embodiment of the present disclosure, the display regions may include at least one mixed-color backlight display region M. Each mixed-color backlight display region M may include a backlight LED array having two or more colors. Each mixed-color backlight display region M may only display an image of one color in a certain time period. In other words, the mixed-color backlight display region M may display images or symbols or like information like a monochrome backlight display region.

According to an embodiment of the present disclosure, there is provided a vehicle, which includes the above described onboard liquid crystal display device.

According to an embodiment of the present disclosure, there is provided a method of manufacturing an onboard liquid crystal display device and the method includes: forming backlight sources 10; and forming the liquid crystal panel 20, which does not include a color filter layer.

In an embodiment, the step of forming the backlight sources includes forming at least one sub-region in the region where the backlight sources are to be formed, and providing backlight sources of a certain color in each sub-region. The backlight sources may include LED light sources 101.

In an embodiment, the manufacturing method further includes arranging the light-shielding element 30 between different sub-regions.

In an embodiment, the step of forming the backlight sources includes arranging backlight sources of at least two colors in the at least one sub-region, the backlight sources of at least two colors are spaced apart from or arranged adjacent to each other, and each backlight source has a color different from that of an adjacent backlight source, the sub-region may be the above described mixed-color backlight display region M. For example, the mixed-color backlight display region M is provided with LEDs of at least two different colors arranged alternately. Exemplarily, red LEDs 101r and green LEDs 101g are arranged alternately within the mixed-color backlight display region M. In an embodiment, the step of forming the backlight sources includes forming at least one mixed-color backlight display region M, and providing light-emitting diodes of at least two different colors in each mixed-color backlight display region M.

Although the present disclosure has been described and illustrated with reference to exemplary embodiments thereof, an ordinary skilled in the art would appreciate that forms and details of these embodiments may be modified without departing from the spirit and scope of the present invention defined by the appended claims.

1. An onboard liquid crystal display device, comprising at least one backlight source and a liquid crystal panel having no color filter layer.

2. The onboard liquid crystal display device according to claim 1, wherein the onboard liquid crystal display device has at least one display region, and each display region is configured to display respective information independently.

3. The onboard liquid crystal display device according to claim 2, wherein the onboard liquid crystal display device further comprises a light-shielding element disposed between different display regions to isolate backlight of the different display regions.

4. The onboard liquid crystal display device according to claim 2, wherein different display regions are provided with backlight sources of different colors.

5. The onboard liquid crystal display device according to claim 2, wherein the at least one display region comprises a first display region configured to display warning information, and the first display region is provided therein with a red backlight source.

6. The onboard liquid crystal display device according to claim 2, wherein the at least one display region comprises a second display region configured to display indication information, and the second display region is provided therein with a green backlight source.

7. The onboard liquid crystal display device according to claim 2, wherein the at least one display region comprises at least one third display region having mixed-color backlight, and the third display region is provided therein with backlight sources of at least two colors which are disposed in a mixed way.

8. The onboard liquid crystal display device according to claim 7, wherein the third display region is configured to display by operating the backlight sources of at least two colors to flicker alternately, or the backlight sources of at least two colors are configured to emit light simultaneously to display a mixed-color image.

9. A method of manufacturing an onboard liquid crystal display device, comprising:
forming at least one backlight source; and
forming a liquid crystal panel without any color filter layer.

10. The method according to claim 9, wherein forming the at least one backlight source comprises: forming at least one first sub-region, and providing a backlight source of a certain color in each first sub-region.

11. The method according to claim 9, further comprising: arranging a light-shielding element between different sub-regions.

12. The method according to claim 9, wherein forming the at least one backlight source comprises: forming at least one second sub-region, and providing backlight sources of at least two colors, which are spaced apart from or adjacent to each other and each has a color different from that of an adjacent backlight source, in each second sub-region.

13. A vehicle, comprising an onboard liquid crystal display device, wherein the onboard liquid crystal display device comprises at least one backlight source and a liquid crystal panel having no color filter layer.

14. The vehicle according to claim 13, wherein the onboard liquid crystal display device has at least one display region, and each display region is configured to display respective information independently.

15. The vehicle according to claim 14, wherein the onboard liquid crystal display device further comprises a light-shielding element disposed between different display regions to isolate backlight of the different display regions.

16. The vehicle according to claim 14, wherein different display regions are provided with backlight sources of different colors.

17. The vehicle according to claim 14, wherein the at least one display region comprises a first display region configured to display warning information, and the first display region is provided therein with a red backlight source.

18. The vehicle according to claim 14, wherein the at least one display region comprises a second display region configured to display indication information, and the second display region is provided therein with a green backlight source.

19. The vehicle according to claim 14, wherein the at least one display region comprises at least one third display region having mixed-color backlight, and the third display region is provided therein with backlight sources of at least two colors which are disposed in a mixed way.

20. The vehicle according to claim 19, wherein the third display region is configured to display by operating the backlight sources of at least two colors to flicker alternately, or the backlight sources of at least two colors are configured to emit light simultaneously to display a mixed-color image.
